(19) United States
(12) Patent Application Publication
(10) Pub. No.: US 2012/0106986 A1
(43) Pub. Date: May 3, 2012

(54) IMAGE FORMING APPARATUS, TONER CONTAINER USED IN THE SAME, AND METHOD FOR DETERMINING SUITABILITY OF TONER CONTAINER

(75) Inventors: Koichi SAITO, Toyokawa-shi (JP); Yusuke Tominari, Toyoake-shi (JP)

(73) Assignee: Konica Minolta Business Technologies, Inc., Tokyo (JP)

(21) Appl. No.: 13/276,756

(22) Filed: Oct. 19, 2011

(30) Foreign Application Priority Data
Oct. 28, 2010 (JP) 2010-242232

(51) Int. Cl. G03G 15/00; G03G 15/08

(52) U.S. Cl. 399/12

(57) ABSTRACT

An image forming apparatus is configured to receive supply of toner from a toner container. The toner container contains the toner and is rotated to supply the toner. The image forming apparatus includes a developer, a container mountable unit, a toner detector, a rotation counter, and a controller. The developer develops an electrostatic latent image on an image carrier using the toner. To the container mountable unit, the toner container is exchangeably mounted. The toner detector detects an amount of the toner supplied from the toner container. The rotation counter counts a number of rotations of the toner container during the supply of the toner. The controller determines whether the toner container is suitable for the image forming apparatus based on a result of detection by the toner detector and based on a result of counting by the rotation counter.

### CROSS-REFERENCE TO RELATED APPLICATIONS

The present application claims priority under 35 U.S.C. §119 to Japanese Patent Application No. 2010-242232, filed Oct. 28, 2010. The contents of this application are incorporated herein by reference in their entirety.

### BACKGROUND OF THE INVENTION

1. Field of the Invention

The present invention relates to an image forming apparatus, a toner container used in the image forming apparatus, and a method for determining suitability of a toner container.

2. Discussion of the Background

With some image forming apparatuses, it is common practice to have an agreement between a supplier and a user in association with maintenance services such as exchange of toner containers. Examples of the agreement include what are called a charge agreement and a kit agreement. Under the charge agreement, the user makes monthly payments according to the number of pages printed over the month, which is managed by a service technician (maintenance specialist). The kit agreement is on a user management basis; the user purchases toner containers. The agreements have completely different charging structures. Specifically, the charge agreement involves no costs for direct purchasing, while the kit agreement involves costs for purchasing toner containers. This necessitates, for the sake of fairness, supply of different toner containers are supplied in accordance with types of agreements with users.

Specifically, conventional practice is to differentiate toner containers in accordance with types of agreements with users (that is, to ensure incompatibility between toner containers of different agreements). Examples include varying the structure of engagement between the toner container and the casing body in accordance with types of agreements, and providing toner containers with a memory chips for identification. The differentiation of toner containers is also required in accordance with, for example, the specifications of toner containers for countries of sale.

Unfortunately, the conventional configurations involve differentiating the structure of engagement between the toner container and the casing body, and providing toner containers with memory chips for identification, so as to ensure incompatibility between toner containers associated with agreements and specifications, despite the fact that commonalization of toner containers is viable. This adds to the total piece-part count and leads to an increased cost. Additionally, in the case of changes made to the agreement or specifications, the structure of engagement between the toner container and the casing body needs to be changed or the content of the memory chip needs to be rewritten. These kinds of work are laborious, leaving room for improvement in terms of convenience.

### SUMMARY OF THE INVENTION

According to one aspect of the present invention, an image forming apparatus is configured to receive supply of toner from a toner container. The toner container contains the toner and is rotated to supply the toner. The image forming apparatus includes a developer, a container mountable unit, a toner detector, a rotation counter, and a controller. The developer is configured to develop an electrostatic latent image on an image carrier using the toner. To the container mountable unit, the toner container is exchangeably mounted. The toner detector is configured to detect an amount of the toner supplied from the toner container. The rotation counter is configured to count a number of rotations of the toner container during the supply of the toner. The controller is configured to determine whether the toner container is suitable for the image forming apparatus based on a result of detection by the toner detector and based on a result of counting by the rotation counter.

According to another aspect of the present invention, a method is for determining a toner container to be mounted on an image forming apparatus. The method includes rotating the toner container to receive supply of toner. An amount of the toner supplied from the toner container in the rotating step is detected. A number of rotations of the toner container in the rotating step is counted. Whether the toner container is suitable for the image forming apparatus is determined based on the amount of the toner detected in the detecting step and based on the number of rotations counted in the counting step.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram illustrating a printer according to an embodiment;

FIG. 2 is a schematic diagram illustrating a toner supply structure;

FIG. 3 is a functional block diagram of the toner supply structure;

FIG. 4 is a diagram illustrating a mode switch screen;

FIG. 5A is a side view of a toner container for a kit agreement;

FIG. 5B is a side view of a toner container for a charge agreement;

FIG. 6A is a side view of a toner container for the kit agreement;

FIG. 6B is a side view of a toner container for the charge agreement;

FIG. 7 is a flowchart of container determination processing;

FIG. 8 is a diagram illustrating a warning screen;

FIG. 9 is a schematic diagram illustrating a toner supply structure according to another embodiment; and

FIG. 10 is a functional block diagram of the toner supply structure.

### DESCRIPTION OF THE EMBODIMENTS

The embodiments will now be described with reference to the accompanying drawings, wherein like reference numerals designate corresponding or identical elements throughout the various drawings.

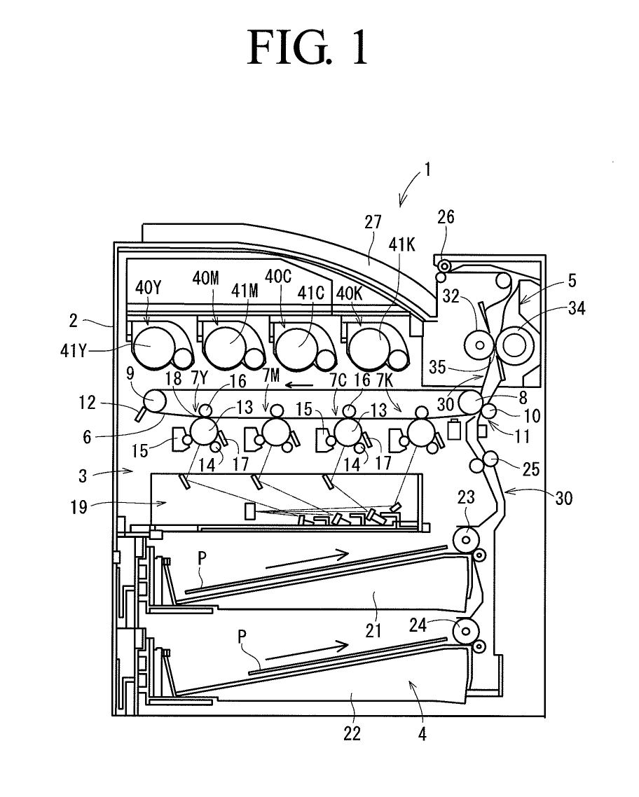

In the embodiments, a tandem color digital printer (hereinafter referred to as a printer) will be described as an example of the image forming apparatus. In the following description, terms (for example, “left and right” and “upper and lower”) indicating specific directions and positions are used where necessary. In this respect, the direction perpendicular to the paper plane of FIG. 1 is defined as front view. The terms are used for the sake of description and will be described not limit the technical scope of the present invention.

### 1. OVERVIEW OF THE PRINTER

First, an overview of a printer 1 will be described by referring to FIG. 1. As shown in FIG. 1, the printer 1 according to this embodiment mainly includes, in a casing 2, an image processor 3, a sheet feeder 4, and a fixing device 5. The printer 1 is coupled to a network such as a LAN so that upon receipt of a print command from an external terminal (not shown), the printer 1 executes printing based on the command, which is not elaborated in the drawings.

The image processor 3 is positioned at a central portion of the casing 2 and transfers toner images on respective photoreceptors 13, which are exemplary image carriers, to a recording medium P. The image processor 3 includes an intermediate transfer belt 6 and a total of four image forming units 7 respectively corresponding to colors of yellow (Y), magenta (M), cyan (C), and black (B). For the sake of description, in FIG. 1, the image forming units 7 are respectively labeled with symbols Y, M, C, and K in accordance with reproduced colors.

The intermediate transfer belt 6 is an endless belt made of a conductive material and is wound across a driving roller 8 and a driven roller 9 respectively disposed on right and left sides at a vertically central position of the casing 2. In this configuration, the intermediate transfer belt 6 rotates in the counter clockwise direction of FIG. 1 as the driving roller 8 is drivingly rotated in the counter clockwise direction of FIG. 1 with power transmitted from a driving motor (not shown).

A secondary transfer roller 10 is disposed on the outer peripheral side of a portion of the intermediate transfer belt 6 wound around the driving roller 8. The secondary transfer roller 10 is in contact with the intermediate transfer belt 6. The intermediate transfer belt 6 and the secondary transfer roller 10 define (at the contact portion) a secondary transfer nip portion 11 as a secondary transfer region. The secondary transfer roller 10 rotates in the clockwise direction of FIG. 1 along with the rotation of the intermediate transfer belt 6 or along with the movement of the recording medium P transferred through the secondary transfer nip portion 11.

A transfer belt cleaner 12 is disposed on an outer peripheral side of a portion of the intermediate transfer belt 6 wound around the driven roller 9. The transfer belt cleaner 12 is in contact with the intermediate transfer belt 6 to remove un-transferred toner remaining on the intermediate transfer belt 6.

Below and along the intermediate transfer belt 6, the four image forming units 7 of yellow (Y), magenta (M), cyan (C), and black (B) are arranged in this order starting on the left side of FIG. 1. The image forming units 7 each include a photoreceptor 13 as an exemplary image carrier that is drivingly rotated in the clockwise direction of FIG. 1. Around the photoreceptor 13, a charger 14, a developer 15, a primary transfer roller 16, and a photoreceptor cleaner 17 are arranged in this order in the clockwise rotational direction of FIG. 1.

The photoreceptor 13 is of negatively charged type and is drivingly rotated in the clockwise direction of FIG. 1 with power transmitted from a photoreceptor motor (not shown). The charger 14 is of roller charging type and is applied a voltage for photoreceptor charging from a charging power supply (not shown) at predetermined time intervals. The developer 15 visualizes the electrostatic latent image on the photoreceptor 13 by reverse development using negatively polarized toner.

The primary transfer rollers 16 are positioned on an inner peripheral side of the intermediate transfer belt 6. The primary transfer rollers 16 each face the photoreceptor 13 of a corresponding one of the image forming units 7 with the intermediate transfer belt 6 interposed therebetween. The primary transfer roller 16 also rotates in the counter clockwise direction of FIG. 1 along with the rotation of the intermediate transfer belt 6. The intermediate transfer belt 6 and each of the first transfer rollers 16 define (at the connected portion) a primary transfer nip portion 18 as a first transfer region. The photoreceptor cleaner 17 is in contact with the photoreceptor 13 to remove un-transferred toner remaining on the photoreceptor 13.

An exposing unit 19 is disposed below the four image forming units 7. The exposing unit 19 forms an electrostatic latent image on each of the photoreceptors 13 using laser beams based on image information from an external terminal and the like. Container mountable units 40 are disposed above the intermediate transfer belt 6. The container mountable units 40 each incorporate a removably disposed toner container 41 containing toner to be supplied to the corresponding developer 15. In FIG. 1, for the sake of description, reference symbols Y, M, C, and K are given to the respective container attaching portions 40 and to the respective toner containers 41 in accordance with reproduced colors.

In each of the image forming units 7, the exposing unit 19 radiates a laser beam to the photoreceptor 13 charged by the charger 14, thus forming an electrostatic latent image. The electrostatic latent image is reverse developed using toner supplied from the developer 15 into a toner image of a corresponding color. At the primary transfer nip portions 18, the toner images of yellow, magenta, cyan, and black are primary transferred in this order on the outer peripheral surface of the intermediate transfer belt 6 from the photoreceptors 13, and superimposed one on top of each other. Un-transferred toner remaining on the photoreceptors 13 is scraped off the photoreceptors 13 by the respective photoreceptor cleaners 17. The superimposed toner images of the four colors are collectively secondary transferred on the recording medium P through the secondary transfer nip portion 11. Un-transferred toner remaining on the intermediate transfer belt 6 is scrapped off the intermediate transfer belt 6 by the transfer belt cleaner 12.

The sheet feeder 4, which is positioned below the image processor 3, includes a plurality of (two in this embodiment) sheet feed cassettes 21 and 22 each accommodating recording media P, feeding rollers 23 and 24 that feed the recording media P one at a time respectively from the sheet feed cassettes 21 and 22, and a pair of resist rollers 25 that convey the fed recording media P to the secondary transfer nip portion 11 (secondary transfer region) at predetermined time intervals. The sheet feed cassette 21 (22) is removably disposed at a lower portion of the casing 2. The recording media P in the sheet feed cassette 21 (22) are sent to a conveyance path 30 one at a time from the top by the rotation of the corresponding feed roller 23 (24).

The conveyance path 30 extends from the sheet feed cassette 21 (22) of the sheet feeder 4 though a nip portion between the resist rollers 25 and the secondary transfer nip portion 11 (secondary transfer region) in the image processor 3, and reaches a fixing nip portion 35 of the fixing device 5. From the fixing nip portion 35, the conveyance path 30 further extends through a pair of discharging rollers 26 to reach a collection tray 27 on the upper surface of the casing 2.

The fixing device 5, which is positioned above the secondary transfer roller 10 in the image processor 3, includes a heating roller 32 elongated in a direction perpendicular to the conveyance direction of the recording medium P, and a pressure roller 34 extending in parallel with the heating roller 32. The pressure roller 34 is in contact with the heating roller 32. The heating roller 32 and the pressure roller 34 define (at the contact portion) the fixing nip portion 35 as a fixing region. The recording medium P past the secondary transfer nip portion 11 and loaded with an unfixed toner image is heated and pressed through the fixing nip portion 35 between the heating roller 32 and the pressure roller 34. Thus, the unfixed toner image is fixed on the recording medium P. Then, the recording medium P is discharged on the collection tray 27 by the rotation of the pair of discharging rollers 26.

### 2. DEVELOPER AND TONER SUPPLY STRUCTURE

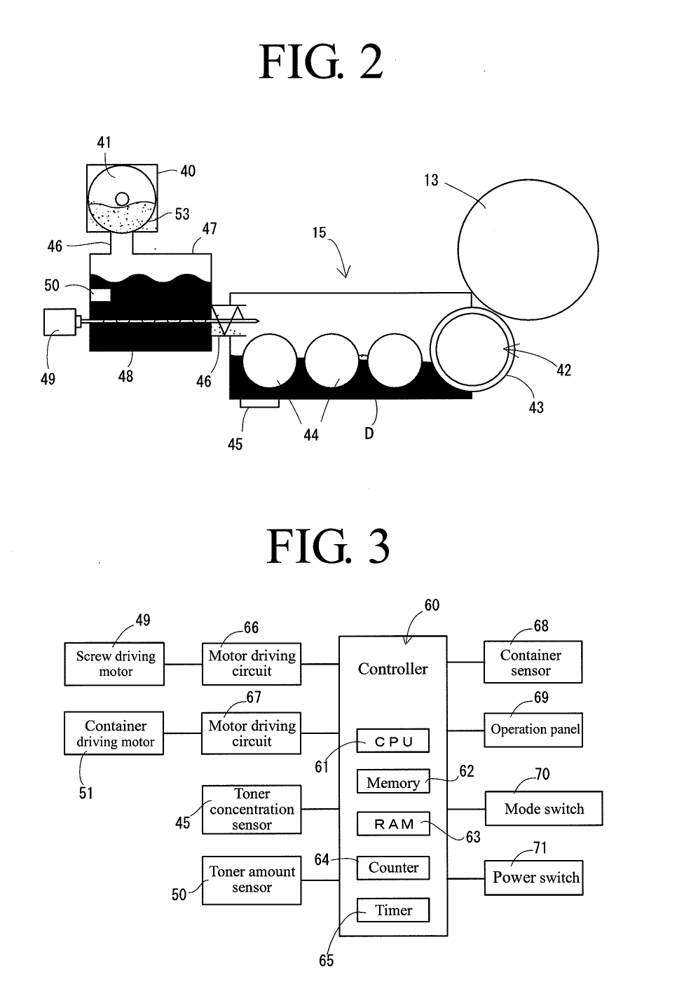

Referring to FIG. 1 and FIG. 2, the developer 15 and a toner supply structure will be described. As shown in FIG. 1 and FIG. 2, each developer 15 employs electrophotography known in the art. The developer 15 includes a developing roller 42 and a plurality of agitators 44. The developing roller 42 includes a plurality of permanent magnets in a cylindrical developing sleeve 43. The plurality of agitators 44 each include a screw impeller. The developer 15 contains a developing agent D of two-component system, which includes toner and carriers. The toner in the developer 15 is agitated and conveyed by the plurality of agitators 44 and delivered by magnetic force onto the surface of the photoreceptor 13 by the carriers bristling on the developing sleeve 43. As a result, the electrostatic latent image on the photoreceptor 13 is developed. The development consumes the toner alone, and not the carrier, out of the developing agent D. In view of this, the carrier is accommodated in the developer 15 in the first place. The consumed toner is compensated by supply of refilling toner.

The developer 15 is attached with a toner concentration sensor 45 that detects the toner concentration (ratio of toner in the developing agent D) in the developer 15. The toner concentration sensor 45 is an exemplary toner detector that detects whether toner is supplied or not in the developer 15. In this embodiment, the toner concentration sensor 45 is of the type that changes its oscillation frequencies in accordance with changes in the toner concentration, which is the mixing ratio between toner and carriers. When the toner concentration in the developer 15 as detected by the toner concentration sensor 45 becomes equal to or less than a predetermined concentration, toner is supplied to the developer 15 from a toner hopper 47 disposed between a container mountable unit 40 and the developer 15.

The container mountable unit 40 is communicatively coupled to the developer 15 through a supply pipe 46. At an intermediate portion of the supply pipe 46, the toner hopper 47, which temporarily stores toner, is disposed. At the bottom of the toner hopper 47, a conveying screw 48 is disposed that supplies the toner in the toner hopper 47 to the developer 15. The conveying screw 48 is coupled to a screw driving motor 49 outside the toner hopper 47 to transmit power. The conveying screw 48 is drivingly rotated by the screw driving motor 49 to supply the toner from the toner hopper 47 to the developer 15.

The toner hopper 47 incorporates a toner amount sensor 50 as an exemplary toner detector that detects whether a predetermined amount of toner is stored in the toner hopper 47. In this embodiment, the toner amount sensor 50 uses a piezoelectric element. When the amount of toner in the toner hopper 47 aspect detected by the toner amount sensor 50 becomes equal to or less than a predetermined amount, toner is supplied to the toner hopper 47 from the toner container 41 in the container mountable unit 40.

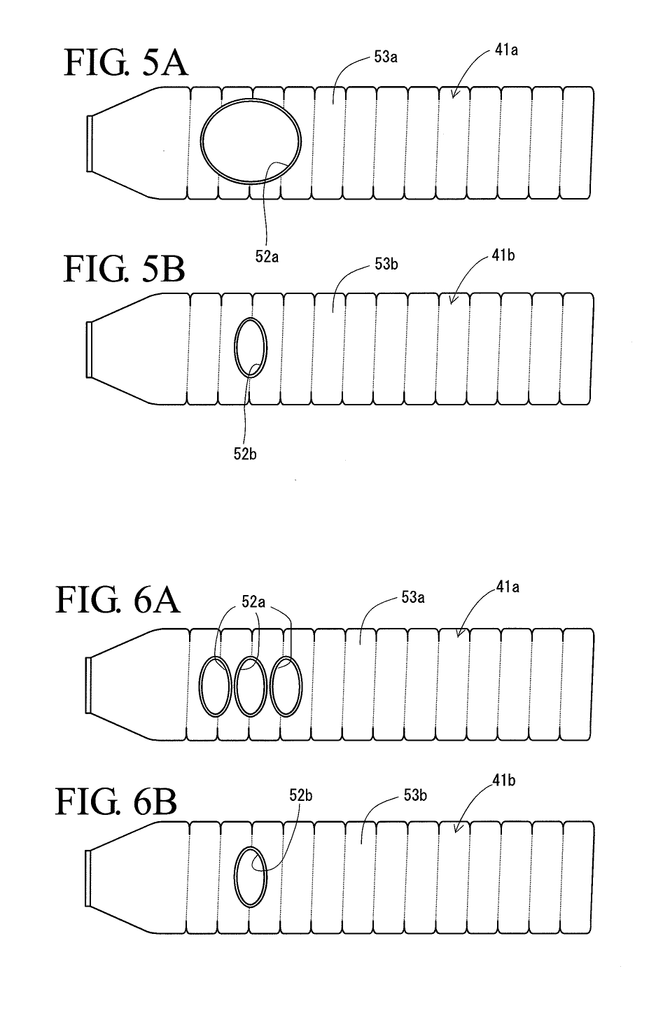

The toner container 41, while being disposed in the container mountable unit 40, is coupled to a container driving motor 51 to transmit power. The toner container 41 is drivingly rotated by the container driving motor 51 to supply toner to the toner hopper 47 through a toner outlet 53 (see FIG. 5 and FIG. 6) formed on an outer periphery portion of the toner container 41.

The casing 2 incorporates a controller 60 as a controller in charge of overall control of the printer 1 (see FIG. 3). The controller 60 includes a CPU 61, a memory 62, a RAM 63, a counter 64, a timer 65, and an input and output interface. The CPU 61 carries out various calculations and control. Examples of the memory 62 include an EEPROM and a flash memory. The RAM 63 temporarily stores a control program and data. The counter 64 serves as a rotation counter that counts, for example, the number of rotations of the container driving motor 51 and the number of transferred recording media P. The timer 65 measures time. The input and output interface transmits and receives data to and from sensors and actuators. The input and output interface of the controller 60 is electrically coupled to, for example, the toner concentration sensor 45, the toner amount sensor 50, a motor driving circuit 66, a motor driving circuit 67, and a container sensor 68. The toner concentration sensor 45 detects the toner concentration in the developer 15. The toner amount sensor 50 detects the amount of toner in the toner hopper 47. The motor driving circuit 66 is for the screw driving motor 49, which rotates the conveying screw 48. The motor driving circuit 67 is for the container driving motor 51, which rotates the toner container 41. The container sensor 68 serves as a container detector that detects whether the toner container 41 is mounted on the container mountable unit 40.

The input and output interface of the controller 60 is also electrically coupled to, for example, an operation panel 69, a mode switch 70, and a power switch 71. The operation panel 69 includes a plurality of keys (buttons) and a liquid crystal display. The mode switch 70 is used for displaying a mode switch screen on the liquid crystal display of the operation panel 69. The operation panel 69 is disposed on a front side (forward side) of the casing 2 of the printer 1, which is not detailed in the drawings. The sensors 45, 50, and 68, and the motor driving circuits 66 and 67 (the motors 49 and 51) are provided for each of the developers 15 of the respective reproduced colors. Thus, the toner supply based on results of detection by the sensors 45, 50, and 68 is independently controlled on a color toner basis.

The counter 64 according to this embodiment counts the number of rotations of the container driving motor 51, thus counting the number R of rotations (number of rotations) of the toner container 41. The container driving motor 51 uses a motor that counts the number of rotations, examples including a stepping motor. This enables the counter 64 to count the number of steps of the container driving motor 51, thereby easily calculating the number of rotations. Thus, the number R of rotations of the toner container 41 is measured. The counter 64 according to this embodiment starts counting the number R of rotations of the toner container 41 upon mounting of the toner container 41 on the container mountable unit 40.

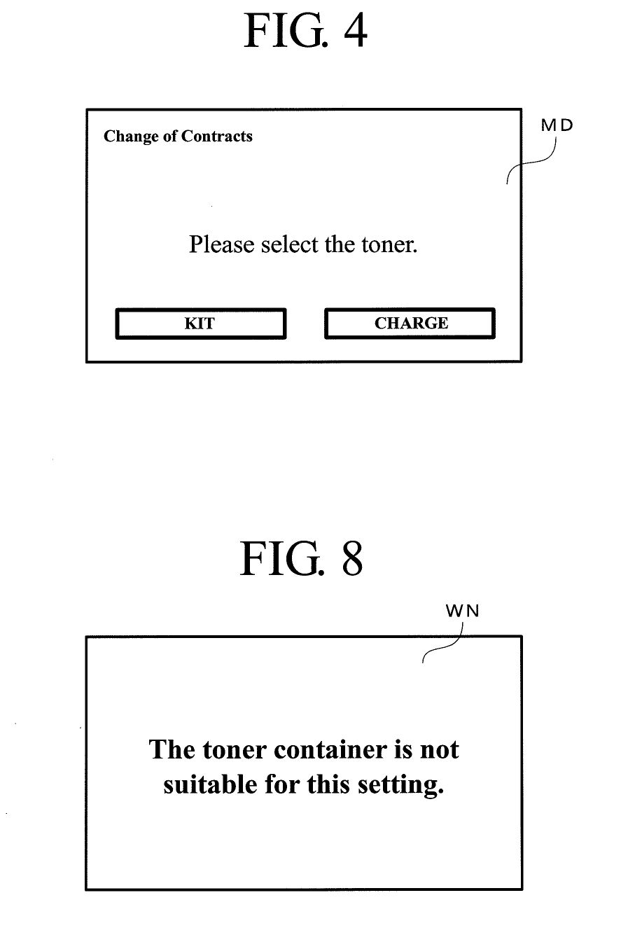

The image forming apparatus 1 according to this embodiment is switchable between two supply modes respectively corresponding to specified numbers Ro of rotations (numbers of rotations) of the toner container 41 at the time of toner supply. The supply modes that are set include a kit mode using a toner container 41 for a kit agreement, and a charge mode using a toner container 41 for a charge agreement. As used herein, the kit agreement is on a user management basis; the user purchases toner containers 41. Under the charge agreement, the user makes monthly payments according to the number of pages printed over the month, which is managed by a service technician (maintenance specialist). The controller 60 displays a mode switching screen MD (mode setter) as shown in FIG. 4 on the liquid crystal display of the operation panel 69 upon implementation of a certain operation on an operation element provided on the casing 2, thus ensuring switchability between the kit mode and the charge mode.

Examples of the operation element include the mode switch 70 and the power switch 71. The mode switching screen MD may be displayed on the liquid crystal display of the operation panel 69 by a predetermined operation of turning on the power switch while pressing the mode switch 70. Preferably, such a predetermined operation procedure is known only to a service technician. The predetermined operation preferably involves complicated procedures before the mode switching screen MD is displayed so as to prevent deliberate or inadvertent changes of setting.

As shown in FIGS. 5A, 5B, 6A, and 6B, the toner container 41 includes a cylindrical container body 53 including the toner outlet 52 on an outer peripheral portion. The container body 53 includes two types of container bodies respectively corresponding to the supply modes. In this embodiment, the container body 53 includes a container body 53a for the kit agreement and a container body 53b for the charge agreement. In the following description and the drawings, the reference numerals of the toner container 41, the container body 53, and the toner outlet 52 will be occasionally followed by alphabets (a or b) respectively corresponding to the two agreements. This is for the purpose of distinctly reciting the reference numerals of the toner container 41, the container body 53, and the toner outlet 52 in accordance with the agreements. Both types of container bodies 53a and b have similar outer shapes (approximately cylindrical outer shapes in this embodiment) while having different toner amounts per rotation (the amount of toner discharged through the toner outlet 52 per rotation of the container body 53).

Specifically, in FIGS. 5A and 5B, a toner container 41a (container body 53a) for the kit agreement has a toner outlet 52a on an outer peripheral portion of the toner container 41a, while a toner container 41b (container body 53b) for the charge agreement has a toner outlet 52b on an outer peripheral portion of the toner container 41b. The toner outlet 52a has an area different from the area of the toner outlet 52b. In this case, the area of the toner outlet 52a for the kit agreement is approximately three times larger than the area of the toner outlet 52b for the charge agreement. In FIGS. 6A and 6B, the number of toner outlets 52a for the kit agreement is different from the number of toner outlets 52b for the charge agreement. In this case, the number of the toner outlets 52a for the kit agreement is three times larger than the number of the toner outlets 52b for the charge agreement. In the examples of FIGS. 5A, 5B, 6A, and 6B, the amount of toner discharged through the toner outlet 52a per rotation is approximately 30 g, while the amount of toner discharged through the toner outlet 52b per rotation is approximately 10 g.

### 3. DESCRIPTION OF CONTAINER DETERMINATION PROCESSING

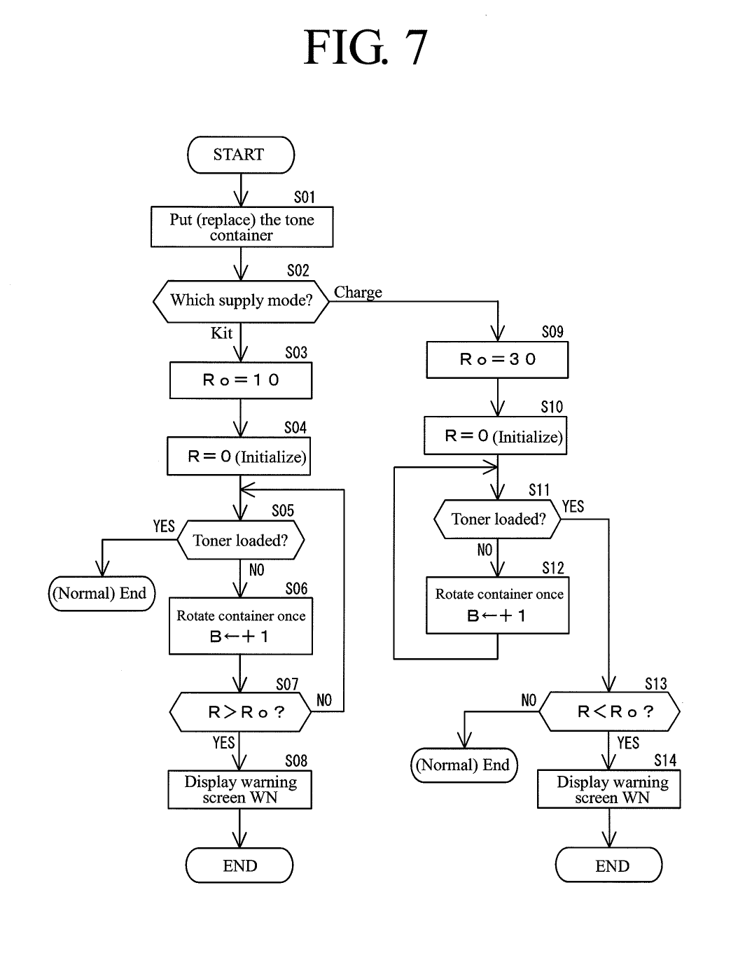

An example of container determination processing by the controller 60 will be described below by referring to FIG. 7. The memory 62 of the controller 60 stores an algorithm represented by the flowchart of FIG. 7 as a program. The program is loaded on the RAM 63 and then executed by the CPU 61. The specified numbers Ro of rotations, which are set for the toner containers 41 (container bodies 53) respectively corresponding to the supply modes, are obtained in advance by an experiment or other means and are preset by being stored in the memory 62 of the controller 60. It is assumed that a supply mode has been selected.

The controller 60 carries out the container determination processing for determining whether the toner container 41 is suitable for the printer 1. The determination is based on the relationship between the amount of toner in the hopper 47 detected by the toner amount sensor 50 and the number R of rotations of the toner container 41 counted by the counter 64. Upon detection by the container sensor 68 that the toner container 41 is mounted (exchanged) on the container mountable unit 40 (S01), the controller 60 determines the currently selected supply mode (S02). When the kit mode is the currently selected mode, the processing proceeds to step S03, and the specified number Ro of rotations of the toner container 41 at the time of toner supply is set at a value (e.g., 10) corresponding to the kit mode. Then, the controller 60 initializes, to zero, the value R of the rotation counter indicating the actual number of rotations (number of rotations) of the toner container 41 (container body 53) (S04). The controller 60 then determines whether toner exists in the toner hopper 47 (whether the toner amount is equal to or more than the predetermined amount) based on the result of detection by the toner amount sensor 50 (S05).

The indication “toner loaded” in step S05 means that with the kit mode selected, the container 41a (container body 53a) for the kit agreement is suitably mounted on the container mountable unit 40. Thus, the toner supply is terminated. With the indication “no toner”, the controller 60 causes the container driving motor 51 to rotate the toner container 41 (container body 53) once, and adds “1” to the value R of the rotation counter (update the value R, S06). Then, the controller 60 determines whether the value R of the rotation counter is more than the specified number Ro of rotations (10) (S07). When the value R of the rotation counter is equal to or less than the specified number Ro of rotations (S07: NO), this means that the toner supply is insufficient, and thus the processing returns to step S05. When the value R of the rotation counter is more than the specified number Ro of rotations (S07: YES), this means that the toner supply is insufficient even in excess of the specified number Ro of rotations, and therefore that the suitable toner container 41a (container body 53a) is not mounted on the container mountable unit 40. In view of this, the controller 60 displays a warning screen WN as shown in FIG. 8 on the liquid crystal display of the operation panel 69 (S08), so as to inform the user that the toner container 41 is not suitable for the currently selected supply mode. In step S08, toner supply from the unsuitable toner container 41 is also prohibited.

Referring back to step S02, when the charge mode is the currently selected mode, the processing proceeds to step S09, and the specified number Ro of rotations of the toner container 41 at the time of toner supply is set at a value (e.g., 30) corresponding to the charge mode. Then, the controller 60 initializes, to zero, the value R of the rotation counter, which indicates the actual number of rotations of the toner container 41 (container body 53) (S10). The controller 60 then determines whether toner exists in the toner hopper 47 based on the result of detection by the toner amount sensor 50 (S11).

The indication “no toner” in step S11 means that the toner supply is still insufficient. Hence, the controller 60 causes the container driving motor 51 to rotate the toner container 41 (container body 53) once, and adds “1” to the value R of the rotation counter (S12). Then, the processing returns to step S11. With the indication “toner loaded”, the controller 60 determines whether the value R of the rotation counter is less than the specified number Ro of rotations (30) (S13). When the value R of the rotation counter is equal to or more than the specified number Ro of rotations (S13: NO), this means that with the charge mode selected, the container 41b (container body 53b) for the charge agreement is suitably mounted on the container mountable unit 40. Thus, the toner supply is terminated. When the value R of the rotation counter is less than the specified number Ro of rotations (S13: YES), this means that the toner supply is sufficient even though the specified number Ro of rotations is unreached, and therefore that the suitable toner container 41b (container body 53b) is not mounted on the container mountable unit 40. In view of this, the controller 60 displays the warning screen WN shown in FIG. 8 on the liquid crystal display of the operation panel 69 (S14), so as to inform the user that the toner container 41 is not suitable for the currently selected supply mode. In step S14, toner supply from the unsuitable toner container 41 is also prohibited. In steps S08 and S14, it is also possible to prohibit printing on the printer 1.

In this embodiment, as the toner detector, the toner amount sensor 50 is exemplified that uses on and off operations in detecting whether a predetermined amount of toner is contained in the toner hopper 47. It is also possible to use a sensor that detects changes in the amount of toner in the toner hopper 47. In this case, the slope of changes in the detected value of the number of rotations of the toner container is compared with the predetermined threshold value of the toner container for the kit agreement and with the predetermined threshold value of the toner container for the charge agreement. This ensures determination as to which of the toner containers is mounted.

### 4. CONCLUSION

As is apparent from the above description, this embodiment ensures immediate identification of, for example, a user's inadvertent use of an unsuitable toner container 41. Specifically, whether the toner container 41 used is suitable for the image forming apparatus 1 is determined reliably with a simple structure. This precludes image formation using an unsuitable toner container (toner) and precludes damage to the image forming apparatus

In particular, the container body 53 has two types, 53a and 53b, respectively corresponding to the supply modes. The container bodies 53a and 53b have similar outer shapes while having different discharge amounts of toner per rotation through the toner outlet 52a and 52b. This eliminates the need for differentiating the structure of engagement between the toner container 41 and the container mountable unit 40 or for providing the toner container 41 with a memory chip for identification. Without these measures, this embodiment ensures commonalization of toner containers 41 while at the same time differentiating the toner containers 41 in accordance with agreements with users and in accordance with, for example, specifications for countries of sale. This improves the versatility of the toner container 41 and leads to cost reductions. This also facilitates the work of changing the agreements or the specifications. Thus, the convenience of the changing work is improved.

### 5. ANOTHER EMBODIMENT OF TONER SUPPLY STRUCTURE

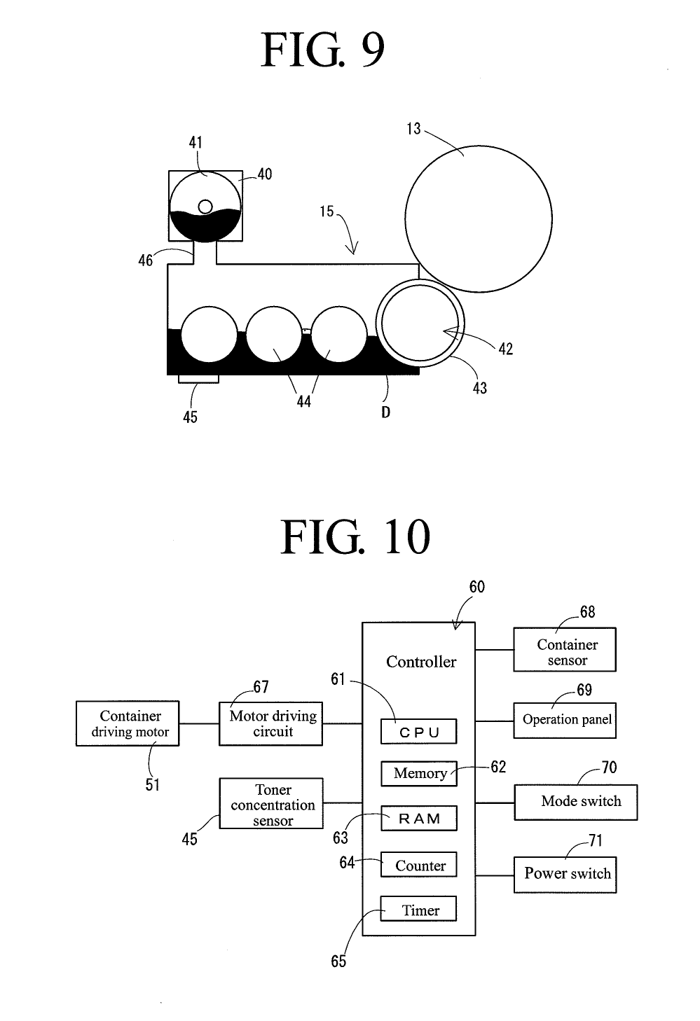

FIG. 9 and FIG. 10 show another embodiment of the toner supply structure. In the other embodiment, the toner hopper 47 is omitted so that toner is directly supplied from the toner container 41 (container body 53) in the container mountable unit 40 to the developer 15. Hence, none of the toner amount sensor 50, the conveying screw 48, the screw driving motor 49, and the motor driving circuit 66 for the screw driving motor 49 are provided. The container determination processing by the controller 60 is basically the same as the one in the above-described embodiment.

Since the toner hopper 47 is not provided, the toner in the toner container 41 is directly supplied into the developer 15. In the developer 15, it is necessary to keep constant the concentration of the toner in the developing agent, which includes the toner and the carriers. Without concentration control, a sharp increase in toner can be significantly detrimental to development performance.

This is addressed by measuring a low toner concentration value T1, which is observed when the toner concentration is low and a supply of toner is needed. This is followed by obtaining the number of rotations of the toner container 41 required before the low toner concentration rises to a predetermined, normally used concentration value T0 (at which the toner concentration is equal to or more than a predetermined concentration). The difference between the low toner concentration value T1 and the normal toner concentration value T0 corresponds to the amount of toner supply in this case. Hence, comparing the toner supply with the obtained number of rotations ensures determination as to whether the mounted toner container 41 is the toner container for the kit agreement or the toner container for the charge agreement, similarly to the above-described embodiment.

### 6. OTHERS

The present invention is not limited to the above-described embodiments and can be embodied in various forms. For example, while a printer has been described as an exemplary image forming apparatus, this should not be construed in a limiting sense. Other possible examples include copiers, fax machines, and multi-function machines integrally incorporating copy and fax capabilities. Moreover, the location or arrangement of individual elements in the illustrated embodiments should not be construed in a limiting sense. Various modifications can be made without departing from the scope of the present invention.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. An image forming apparatus configured to receive supply of toner from a toner container, the toner container containing the toner and being rotated to supply the toner, the image forming apparatus comprising:
a developer configured to develop an electrostatic latent image on an image carrier using the toner;
a container mountable unit to which the toner container is exchangeably mounted;
a toner detector configured to detect an amount of the toner supplied from the toner container;
a rotation counter configured to count a number of rotations of the toner container during the supply of the toner; and
a controller configured to determine whether the toner container is suitable for the image forming apparatus based on a result of detection by the toner detector and based on a result of counting by the rotation counter.

2. The image forming apparatus according to claim 1, further comprising a mode setter configured to set one of a plurality of supply modes in accordance with a type of the toner container,
wherein the controller is configured to determine whether the toner container is suitable for the image forming apparatus based on a number of rotations of the toner container specified individually for each of the plurality of supply modes set by the mode setter.

3. The image forming apparatus according to claim 1, further comprising a container detector configured to detect whether the toner container is mounted on the container mountable unit,
wherein the rotation counter is configured to start counting the number of the rotations of the toner container when the container detector detects mounting of the toner container on the container mountable unit.

4. The image forming apparatus according to claim 1, further comprising a toner hopper between the container mountable unit and the developer, the toner hopper being configured to temporarily store the toner from the toner container mounted on the container mountable unit and configured to supply the toner to the developer,
wherein the toner detector is disposed in the toner hopper to detect an amount of the toner in the toner hopper, and
wherein the controller controls the toner to be supplied to the toner hopper from the toner container mounted on the container mountable unit based on a result of detection by the toner detector.

5. The image forming apparatus according to claim 1,
wherein the toner detector is disposed in the developer to detect an amount of the toner in the developer, and
wherein the controller controls the toner to be supplied to the developer from the toner container mounted on the container mountable unit based on a result of detection by the toner detector.

6. A toner container used in the image forming apparatus according to claim 2, the toner container comprising at least two container bodies each comprising at least one toner outlet on an outer peripheral portion, the at least two container bodies having similar outer shapes and discharging different amounts of toner per rotation from the toner outlet.

7. The toner container according to claim 6, wherein the at least one toner outlet of one of the toner container bodies has an area different from an area of the at least one toner outlet of the other toner container body.

8. The toner container according to claim 6, wherein the at least one toner outlet of the one of the toner container bodies and the at least one toner outlet of the other toner container body each comprise a different number of toner outlets.

9. A method for determining a toner container mounted on an image forming apparatus, the method comprising:
rotating the toner container to receive supply of toner;
detecting an amount of the toner supplied from the toner container in the rotating step;
counting a number of rotations of the toner container in the rotating step; and
determining whether the toner container is suitable for the image forming apparatus based on the amount of the toner detected in the detecting step and based on the number of rotations counted in the counting step.

10. The method according to claim 9, further comprising setting one of a plurality of supply modes in accordance with a type of the toner container,
wherein the determining step comprises determining whether the toner container is suitable for the image forming apparatus based on a number of rotations of the toner container specified for each of the plurality of supply modes, set in the setting step.

11. The method according to claim 9, further comprising detecting whether the toner container is mounted on the image forming apparatus,
wherein the counting step of counting the number of the rotations of the toner container is started when the toner container is detected to be mounted on the image forming apparatus.
